(19) United States
(12) Patent Application Publication
(10) Pub. No.: US 2013/0307691 A1
(43) Pub. Date: Nov. 21, 2013

(54) ELECTRONIC LOCK WITH OPTICAL DETECTION FOR DETECTING AN ENABLER

(71) Applicants: Ricardo Sendín Martín, Mendaro (ES); Sergio Pérez Urruticoechea, Bilbao (ES)

(72) Inventors: Ricardo Sendín Martín, Mendaro (ES); Sergio Pérez Urruticoechea, Bilbao (ES)

(73) Assignee: OJMAR, S.A., Elgoibar (ES)

(21) Appl. No.: 13/475,516

(22) Filed: May 18, 2012

(51) Int. Cl. G06F 7/04; E05B 45/06

(52) U.S. Cl. 340/542; 340/5.67; 340/5.51; 340/5.61; 340/5.53

(57) ABSTRACT

An electronic lock includes optical detection for detecting an enabler (card or coin), including an inserter (1) for allowing the introduction of an enabler (2) in the lock (10); a retainer (5) for retaining the enabler (2) in a reading position; an optical detector (4) for detecting the enabler (2) when it is introduced in the reading position; an interactive device (7) for capturing a user access information; a control module for receiving and verifying the access information and the information from the optical detecotr (4) and if both verifications are correct, generating a signal for operating the lock.

### FIELD OF THE INVENTION

The present invention is encompassed within the field of electronic locks.

### BACKGROUND OF THE INVENTION

Locks known today have many mechanical components to perform the tasks of coin and/or card detection. Due to their many components locks are devices which require complex manufacturing and maintenance.

### DESCRIPTION OF THE INVENTION

This invention presents a lock with an optical detection for detecting an enabler (e.g. coin, card) reducing the number of mechanical components necessary to perform this function. The lock also has good water and dust resistance protecting the electronics and the mechanical components thereof by using a contact-free optical detection since it can facilitate isolating the inside of the lock by means of using a transparent display welded to the casing of the lock.

The operation of the lock is associated both with the introduction of an enabler (coin/card) in insertion means and with enabling the lock through an interaction module.

The insertion means can comprise a slot and/or a channel or track through which the enabler is introduced. For the particular case of coin detection the insertion means can have different diameters to allow inserting different types of coin. For card detection the insertion means are adapted to the size thereof, being wide enough as to allow introducing the card (preferably in a vertical position).

The lock has an interaction module which enables using the lock by transferring the access information received by a user from the outside to a control module which performs the verification thereof.

The use of the lock can be enabled in different manners, for example, by means of introducing an alphanumeric combination in a keypad, by means of incorporating a transponder (preferably an RFID transponder) or by means of digital fingerprint recognition means.

In the aforementioned cases, the interaction module receives information from the outside which enables closing or opening the lock but it also allows authenticating the user either by means of a numerical introduction of a password through the keypad or by means of receiving an external signal and the subsequent emission to the control module of the lock through the transponder or by means of capturing a series of parameters from the digital fingerprint of the user.

If an enabler (for example, a coin or a card) is not introduced in the insertion means and/or the user does not use the interaction module properly, the lock does not allow closing same.

The invention thus regulates the use of the locks, favoring a responsible and moderate use thereof by requiring the introduction of an enabler for using them and controls their use through recognition means which can comprise the interaction module.

To close the lock, the user introduces an enabler (normally a coin or a card) in the insertion means of the lock and enables closing the lock through the interaction module if this is confirmed by the verification performed by the control module. If the control module verifies that the access performed through the interaction module is valid, it operates retention means which in the case of using the coin cause the retention on the detection means thereof, whereas in the case of the card it can comprise a pin or stop to allow introducing the card a certain length and the verification can be correctly performed by the detection means.

To open the lock the control module only needs to know the user's identifier with which it has been closed.

The invention detects the enabler through detection means comprising an optical sensor capable of emitting and receiving light such that when the sensor receives the light from the reflection of the light emitted and reflected in the enabler, the sensor informs the control module contained in the lock itself. Putting in any coin or card is sufficient to open/close the gate since it only detects whether there is something in front of the sensor. In the case of a correct enabler detection, the control module activates mechanical means which perform the convenient physical opening or closing of the lock or sends a signal to an external element so that it performs the opening/closing.

If the user performs a valid access through the interaction module for opening or closing the lock but the control module does not receive any signal from the detection means because the optical sensor has not detected any light due to the absence of the enabler, the control module activates warning means to indicate to the user that the lock is not working normally.

To supply power to the detection means, control means and warning means, the lock can comprise power supply means or could be powered externally.

The user informs the control module to activate the mechanical means and open the lock through the interaction module. Once the lock is opened, in the case of using a coin the retention means are deactivated to release the coin retained on the sensor (for example, the user can move a lever to cause such deactivation of the retention means), whereas in the case of using a card the user removes the card from the same place through which it has been introduced. Since it is free, the coin is deposited in collecting means so that the user can collect it easily.

It is important to highlight that the lock object of the present invention may or may not incorporate the mechanical means for performing the physical opening or closing of the lock. If it incorporates the mechanical means, the control module is responsible for their activation (opening or closing). If it does not incorporate the mechanical means, the control module is responsible for transmitting a signal to an external element (which can be the mechanical means themselves) so that it opens or closes the lock depending on the signal.

### BRIEF DESCRIPTION OF THE DRAWINGS

Drawings which aid to better understand the invention and relate specifically to an embodiment of said invention depicted by way of non-limiting example thereof is described briefly below.

FIGS. 1A and 1B schematically show an elevational view of the coin detection module and the card detection module of the lock, respectively.

FIG. 2A and 2B schematically show the elements comprised in the coin detection module and the card detection module, respectively, without the cover thereof when the coin/card is being detected by the sensor.

FIGS. 3A and 3B schematically show the elements comprised in the coin detection module and the card detection module, respectively, without the cover thereof when the coin drops after opening the lock or when the card is extracted.

FIG. 4 depicts by way of example the interaction means of the lock.

### DETAILED DESCRIPTION OF AN EMBODIMENT

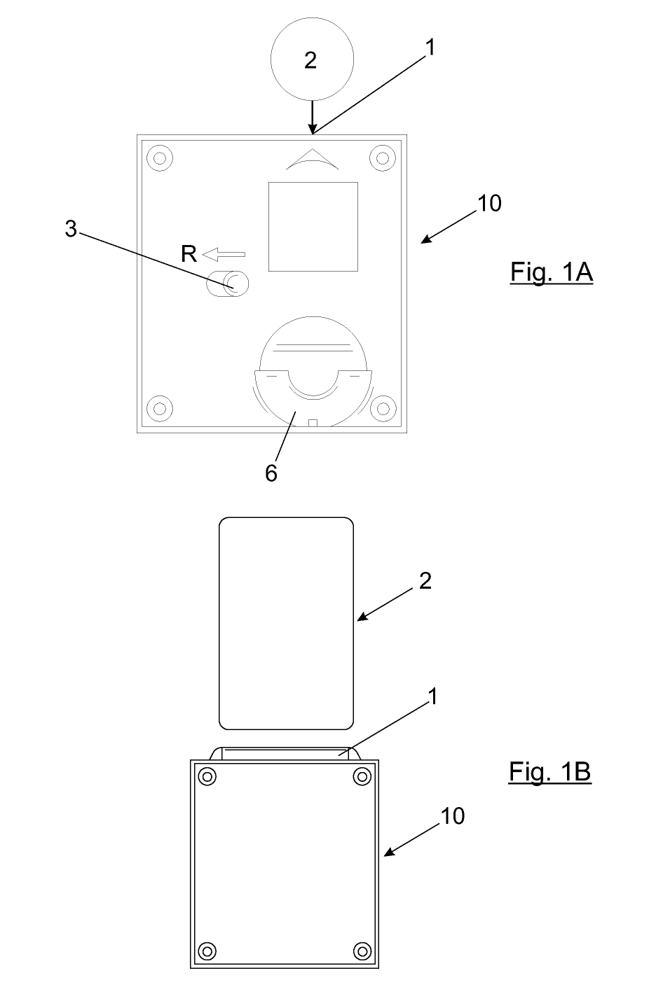

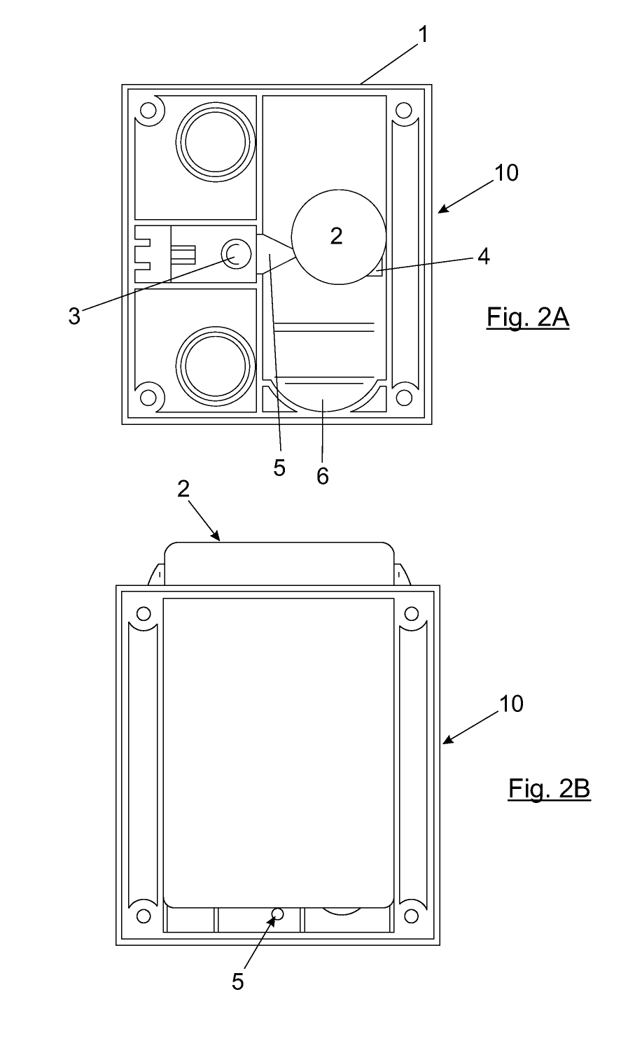

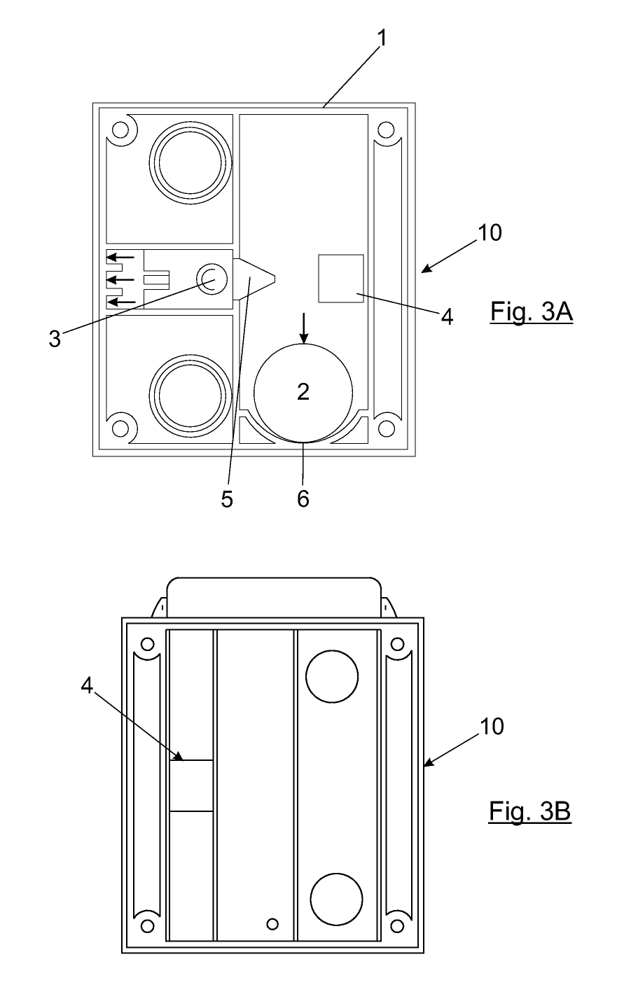

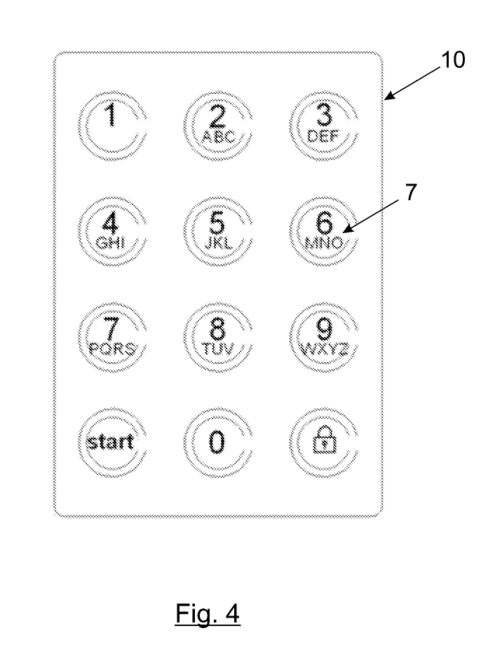

The lock with optical detection object of the present invention can be applied to coins or cards. FIGS. 1A, 2A and 3A depict the particular embodiment of the lock for coin detection, whereas FIGS. 1B, 2B and 3B depict the particular case for card detection. FIGS. 1A and 1B depict the enabler 2 of the lock, which can be a coin (FIG. 1A) or a card (FIG. 1B), as it approaches the lock. FIGS. 2A and 2B show the enabler 2, coin (FIG. 2A) or card (FIG. 2B), once introduced in the lock 10, when it is being detected. FIGS. 3A and 3B schematically show the elements comprised in the detection module of the lock. Said Figures do not depict the interaction means (these are shown by way of example in FIG. 4) or the mechanical means for the physical opening/closing of the lock (the latter can be external elements outside the lock of the present invention). The control module which is a module with data processing means, inputs and outputs (for example, a microcontroller) is also not depicted.

The lock with optical detection for detecting coins comprises:
insertion means 1 configured for receiving a coin 2;
interaction means 7 transferring the access information received from the outside to a control module. A keypad is depicted by way of example in FIG. 4 as interaction means;
detection means 4, preferably an optical detector comprising an optical sensor configured for emitting light and for receiving the light from the reflection of the light emitted in coin 2;
the retention means 5 which, activated by the control module, retain the coin 2 on the detection means 4, and which, activated by the movement of a lever 3, release the coin 2 retained on the detection means 4;
a control module managing the information received by the interaction means 7 and by the detection means 4;
mechanical means activated by the control module and responsible for performing the physical opening and closing of the lock;
collecting means 6 configured for collecting the coin 2 released by the retention means 5;
power supply means powering the interaction means 7, the detection means 4 and the control module.

In the embodiment of the card the retention means 5 can comprise a stop, for example, to allow introducing the card only up to a certain length.

The lock will preferably comprise warning means to warn the absence of a coin detected by the detection means 4.

The interaction module (or interaction means) 7 preferably comprises a keypad, digital fingerprint recognition means or an RFID transponder. Each of these embodiments being able to be combined.

The control module is preferably configured for verifying the access information introduced by the user through the interaction means 7.

Once the invention has been clearly described, it must be stated that the particular embodiments described above are susceptible to detail modifications as long as they do not alter the fundamental principal and the essence of the invention.

1. An electronic lock with optical detection for detecting an enabler, comprising:
inserting means configured for allowing the introduction of an enabler in the lock;
retention means responsible for allowing the retention of the enabler in a reading position;
optical detecting means responsible for detecting the enabler when the enabler is introduced in the reading position;
interacting means responsible for capturing a user access information;
a control module responsible for receiving and verifying said access information and the information from the optical detecting means and if both verifications are correct, generating a signal for operating the lock.

2. The lock according to claim 1, wherein the enabler is a card.

3. The lock according to claim 1, wherein the enabler is a coin.

4. The lock according to claim 3, wherein the retaining means are activated by the control module and are released by the movement of a lever to allow releasing the coin.

5. The lock according to claim 3, further comprising collecting means configured for collecting the coin once the retaining means have been released.

6. The lock according to claim 1, further comprising mechanical means activated by the control module and responsible for opening or closing the lock.

7. The lock according to claim 1, further comprising power supply means to power the interacting means, the optical detecting means and the control module.

8. The lock according to claim 1, wherein the optical detecting means comprise an optical sensor configured for emitting light and for receiving light from reflection of the light emitted in the enabler.

9. The lock according to claim 1, further comprising warning means for warning warn the absence of coin detected by the optical detection means.

10. The lock according to claim 1, wherein the interacting means comprise a keypad.

11. The lock according to claim 1, wherein the interacting means comprise digital fingerprint recognizing means.

12. The lock according to claim 1, wherein the interacting means comprise an RFID transponder.
